(19) United States
(12) Patent Application Publication
(10) Pub. No.: US 2009/0239689 A1
(43) Pub. Date: Sep. 24, 2009

(54) LACROSSE STICK SHAFT HAVING A PLURALITY OF CAVITIES THEREIN

(75) Inventors: Stuart Robertson Baxter, Eden Prairie, MN (US); Yvonne Margareta Kukora, Reading, PA (US); Michael Scott Tabb, JR., Potomac, MD (US); Robert Andrew Klink, Collegeville, PA (US); Whitney Edna Cameron Clark, Ridgewood, NJ (US); Gregory Andrew Furst, Indianapolis, IN (US)

Correspondence Address: SAND & SEBOLT, AEGIS TOWER, SUITE 1100, 4940 MUNSON STREET, NW, CANTON, OH, 44718-3615, US

(73) Assignee: HENSON COMPANY, INC., Sinking Spring, PA (US)

(21) Appl. No.: 12/408,041

(22) Filed: Mar. 20, 2009

Related U.S. Application Data
(60) Provisional application No. 61/038,909, filed on Mar. 24, 2008.

(51) Int. Cl. A63B 59/02; F16L 9/19

(52) U.S. Cl. 473/513; 138/114; 138/177

(57) ABSTRACT

A shaft for sporting equipment comprises an elongate outer wall with a longitudinal bore extending between its first and second ends. An X-shaped web is disposed within the bore and extends along the entire length thereof. The web has four legs that radiate outwardly from a central core and connect to the outer wall. At least one longitudinal opening is defined in the outer wall. The outer wall and web define at least one closed cavity in the shaft. The outer wall, web and opening further define at least one open cavity in the shaft.

### CROSS REFERENCE TO RELATED APPLICATIONS

This application claims priority from U.S. Provisional Application Ser. No. 61/038,909 filed Mar. 24, 2008; the disclosure of which is incorporated herein by reference.

### BACKGROUND OF THE INVENTION

1. Technical Field

The present invention relates generally to sports shafts. More particularly, the present invention relates to sports shafts for use when playing lacrosse. Specifically, the invention relates generally to sports shafts which are attached to a lacrosse stick head and which have a relatively constant cross-sectional configuration.

2. Background Information

Original lacrosse handles were constructed of wood. Those wood handles were shaped such that the lacrosse handle and the lacrosse head were a single integral wood structure. These wooden lacrosse handles suffered from a variety of disadvantages. Initially, these wooden handles were susceptible to damage from excess exposure to water such as through warping. Further, these prior wooden handles were heavy and somewhat cumbersome and also susceptible to breakage. Moreover, because the wood had to be bent to form the sidewall and scoop, a significant amount of time was involved in forming or making each of these wooden lacrosse handles, which made them relatively expensive. Because the lacrosse handle and head were a single structure, if any portion of the head or the handle broke or was damaged, the entire wooden handle and head would need to be replaced.

Subsequently, plastic lacrosse heads were developed. These heads were intended to be attached to a lacrosse handle. As the lacrosse head and the lacrosse handle were separate components, they could be manufactured separately. If either the lacrosse head or the lacrosse handle became damaged or broken, each component could be replaced individually. The original handles for attachment to these plastic heads were still constructed of wood.

Metal and composite lacrosse handles have since been developed to attach to these plastic heads. Metal handles tend to be less expensive and somewhat more resistant to damage. However, they can be somewhat difficult to grip and breakage or bending is still relatively common. Therefore, a need exists for a lacrosse handle that has increased durability without increasing the weight thereof. A need also exists for a lacrosse handle which provides a more positive form of tactile feedback and which allows the handle to be more aggressively gripped.

### BRIEF SUMMARY OF THE INVENTION

The device of the present invention is a shaft for a piece of sporting equipment such as a lacrosse stick. The shaft comprises an elongate outer wall with a longitudinal bore extending between its first and second ends. An X-shaped web is disposed within the bore and extends along the entire length thereof. The web has four legs that radiate outwardly from a central core and connect to the outer wall. At least one longitudinal opening is defined in the outer wall. The outer wall and web define at least one closed cavity in the shaft. The outer wall, web and opening further define at least one open cavity in the shaft. The opening provides a place for the athlete to position at least a portion of their hand or glove to orient the shaft for play and to aid in more aggressively gripping the shaft.

### BRIEF DESCRIPTION OF THE SEVERAL VIEWS OF THE DRAWINGS

The preferred embodiment of the invention, illustrated of the best mode in which Applicant contemplates applying the principles of the invention, is set forth in the following description and is shown in the drawings and is particularly and distinctly pointed out and set forth in the appended claims.

FIG. 1 is a perspective view of a lacrosse stick of the present invention.

FIG. 2 is a side elevational view of the lacrosse stick of the present invention.

FIG. 3 is a sectional view taken along sectional line 3-3, FIG. 1.

FIG. 4 is an enlarged perspective view of the handle portion of the lacrosse stick shown in FIG. 1.

Similar numbers refer to similar parts throughout the drawings.

### DETAILED DESCRIPTION OF THE INVENTION

In the following figures, the same reference numbers are used to identify the same components in the various views.

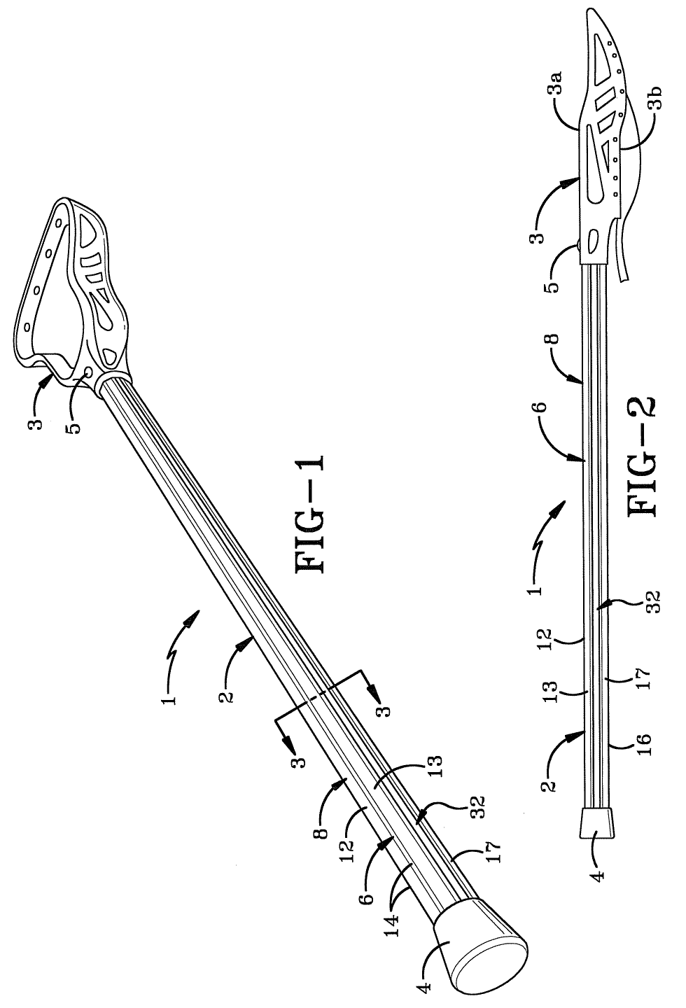

Referring to FIG. 1, lacrosse stick 1 is shown generally and provides a shaft 2 attached on one end to a head 3 and on the opposite end to an end cap 4. Head 3 is attached to shaft 2 by any conventional means, and in the preferred embodiment a fastener 5 is provided for this purpose. The method of attachment is well-known in the art.

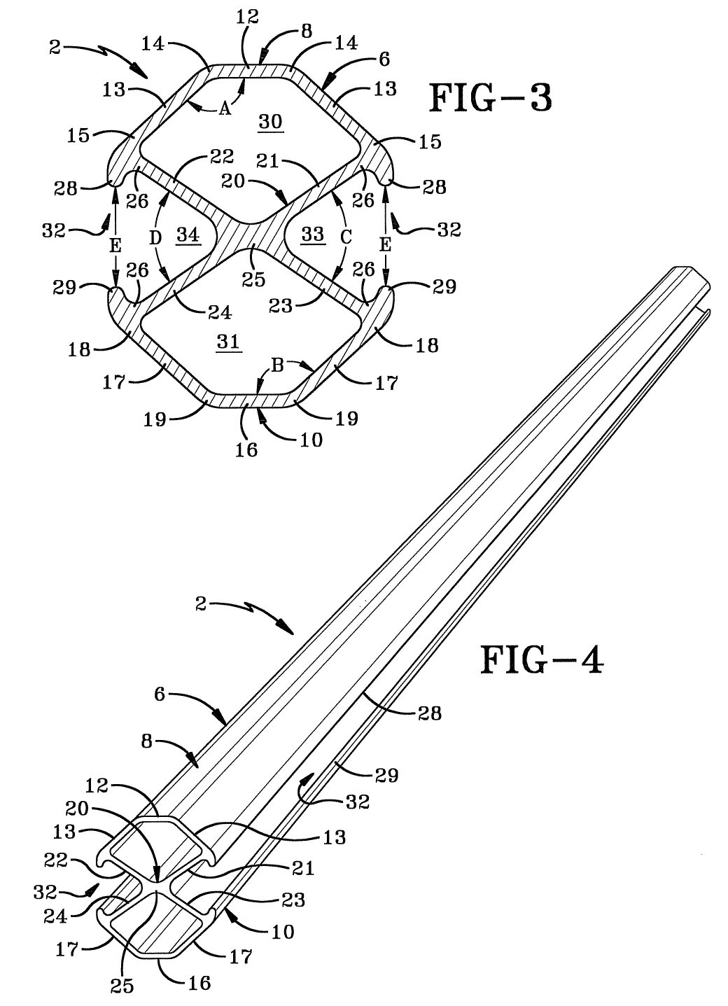

Referring more particularly to FIGS. 3 and 4 and in accordance with one of the primary features of the present invention, shaft 2 will be described in greater detail. Shaft 2 is an elongate member provided with an outer wall 6. Outer wall 6 is generally octagonal in cross-sectional shape and includes an upper portion 8 and a lower portion 10. Upper portion 8 includes a top wall 12 and a pair of upper angled sidewalls 13. Each upper angled sidewall 13 has an attached end 14 and a free end 15. Attached end 14 of each upper angled sidewall 13 is integrally formed with one of the edges of upper portion 8. Additionally, upper angled sidewalls 13 extend downwardly and away from top wall 12 at a constant and similar angle. Although a number of angles are possible, in the preferred embodiment, angle A is in the range of from 100 degrees to 150 degrees and more particularly between 135 degrees and 140 degrees. Specifically, angle A in the preferred embodiment is 138 degrees.

Lower portion 10 of outer wall 6 is formed by a bottom wall 16 and a pair of outwardly extending lower angled sidewalls 17. Lower angled sidewalls 17 are formed with a free end 18 and an attached end 19. Attached end 19 of each lower angled sidewall 17 is connected to one of the edges of bottom wall 16. Lower angled sidewalls 17 extend outwardly and upwardly from bottom wall 16 and define an angle B. Angle B is similar to angle A. In the preferred embodiment, extends in the range of 100 degrees to 150 degrees, and more particularly, from 135 degrees to 140 degrees. Specifically, angle B, similar to angle A, is 138 degrees.

Upper portion 8 and lower portion 10 of outer wall 6 are vertically aligned but spaced apart from one another by way of a web 20. Web 20 is substantially X-shaped and includes a right upper leg 21 and a left upper leg 22, as well as a right lower leg 23 and a left lower leg 24. Right upper leg 21 and right lower leg 23 are divergent in nature and extend outwardly away from each other and define an included angle C. Included angle C in the range of 30 degrees to 80 degrees, and more particularly in the range of 60 degrees to 70 degrees. Specifically, the angle C is approximately 67.6 degrees. Similarly, left upper leg 22 and left lower leg 24 extend outwardly away from each other and define an included angle D. Angle D has a range of between 30 degrees and 80 degrees and more particularly in the range of 60 degrees to 70 degrees. Similar to angle C, angle D has a value more specifically of 67.6 degrees. All of legs 21, 22, 23 and 24 extend outwardly through included angles C and D from a core 25. Core 25 is geometrically centered between upper portion 8 and lower portion 10 and more particularly between top wall 12 and bottom wall 16. Legs 21, 22, 23 and 24 act as stiffening members that firmly support upper and lower portions 8, 10 of outer wall 6.

In further accordance with the invention, each leg 21, 22, 23 and 24 has a free end 26 spaced from core 25. Free ends 26 of right upper leg 21 and left upper leg 22 each connect to free ends 15 of upper angled sidewalls 13, respectively. A small lip 28 extends vertically downwardly relative to this inner connection. Similarly free ends 26 of right lower leg 23 and left lower leg 24 extend outwardly and connect to the free end 18 of each lower angled sidewall 17. A lip 29 extends vertically upwardly from this inner connection and toward lip 28. Each respective pair of lips 28 and 29 defines an opening 32 thereinbetween that is a spaced distance E in size. In accordance with one of the primary features of the present invention, spaced distance E between right upper leg 21 and right lower leg 23 is equal to the spaced distance between left upper leg 22 and left lower leg 24. In the preferred embodiment of the present invention, spaced distance E is between 3 mm and 9 mm in width. Openings 32 preferably extend the entire length of shaft 2.

As is evident from the above discussion and as is illustrated in FIGS. 3 and 4, upper portion 8 of outer wall 6 and right upper leg 21 and left upper leg 22 define an upper cavity 30. Upper cavity 30 extends from one end of the shaft 2 to the other, i.e., from the end of shaft 2 proximate end cap 4 to the end of the shaft 2 proximate head 3. Similarly, lower portion 10 of outer wall 6 and right lower leg 23 and left lower leg 24 define a lower cavity 31. Lower cavity 31 extends between the end of shaft 2 proximate end cap 4 and the end of shaft 2 proximate head 3. Upper and lower cavities 30, 31 extend substantially parallel to a longitudinal axis of shaft 2 and are similar and opposite.

In accordance with a specific feature of the present invention, each cavity 30 and 31 is a closed cavity in that it provides an entire perimeter wall in cross-section. The perimeter wall for cavity 30 is defined by upper wall 12, upper angled sidewalls 13, right upper leg 21 and left upper leg 22. The perimeter wall for cavity 31 is defined by lower wall 16, lower angled sidewalls 17, right lower leg 23 and left lower leg 24.

In accordance with another specific feature of the present invention, shaft 2 also defines two cavities 33, 34 that are open in cross-section. Cavities 33, 34 are open in that they do not provide an entire perimeter wall in cross-section. Cavity 33 is defined by right upper leg 21 and right lower leg 23, connected at core 25 and the associated lips 28, 29 of upper and lower angled sidewalls 13, 17. Cavity 34 is defined by left upper leg 22 and left lower leg 24, connected at core 25 and the associated lips 28, 29 of upper and lower angled sidewalls 13, 17. In each instance, the upper legs 21, 22 are disposed at an angle C relative to the lower legs 23, 24 and the perimeter wall of the open cavity is broken between lips 28, 29 by opening 32.

Shaft 2 of the present invention therefore has an X-shaped interior web 20 that supports a generally octagonal outer wall 6 comprised of upper and lower portions 8, 10 disposed opposite each other and separated from each other by a pair of opposed openings 32. The upper portion 8 includes three of the angled wall members that make up the octagonal shape of the outer wall, those wall members being walls 13, 12, 13. The lower portion 10 also includes three of the angled wall members that make up the octagonal cross-sectional shape of outer wall 6, those wall members being walls 17, 16, 17. The remaining two areas of the octagonal shape are formed by the opposed pairs of lips 28, 29 separated from each other by openings 32.

In operation, shaft 2 is secured to head 3 and end cap 4 in such a way that the openings 32 are oriented so as to fall on the sides of the shaft 2. One of the upper and lower walls 12, 16 faces forwardly with the front 3a of head 3, and the other of the upper and lower walls 12, 16 faces rearwardly with the back 3b of head 3. In operation, the user can more aggressively grip the shaft 2 by allowing a portion of their hand or glove to extend through one or both of openings 32. The lacrosse player also feels the opening 32 when they grasp shaft 2 and they can therefore more easily orient the lacrosse stick during play. Additionally, inasmuch as web 20 provides sufficient strength through the interconnection at core 25 and shaft 2, lacrosse stick 1 is rigid and resists breakage and bending.

While the shaft 2 of the present invention has been described as being useful in a lacrosse stick, it will be understood that this type of configuration would also be suited for use in other sporting equipment shafts such as hockey sticks, tennis racquets etc.

It will further be understood that while the shaft has been described as having a pair of closed cavities 30, 31 and a pair of open cavities 33, 34, the shaft may be provided with a single closed cavity and a single open cavity, where the single open cavity will form a slot that runs the length of one of the sidewalls of the shaft. It should also be understood that the shaft may include more than two closed cavities with one or more open cavities.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A shaft for sporting equipment comprising:
an elongate outer wall having a first end and a second end and a longitudinal axis extending therebetween;
at least one open cavity defined in the outer wall; and
at least one closed cavity defined in the outer wall.

2. The shaft as defined in claim 1, wherein the at least one open cavity is oriented parallel to the longitudinal axis and extends between the first and second ends of the outer wall.

3. The shaft as defined in claim 1, wherein the at least one closed cavity is oriented parallel to the longitudinal axis and extends between the first and second ends of the outer wall.

4. The shaft as defined in claim 1, wherein the outer wall includes an upper portion and a lower portion; and a pair of opposed open cavities are disposed between said upper and lower portions, and wherein each of said open cavities defines an opening in the outer wall that extends between the first and second ends thereof.

5. The shaft as defined in claim 4, wherein the upper portion comprises:
an upper wall and a pair of upper angled sidewalls extending outwardly away from the upper wall and at an angle thereto; and
the lower portion comprises a lower wall and a pair of lower angled sidewalls extending outwardly away from the lower wall and at the same angle thereto.

6. The shaft as defined in claim 5, wherein the angle is in the range of 100 degrees to 150 degrees.

7. The shaft as defined in claim 6, wherein the angle is between 135 degrees and 140 degrees.

8. The shaft as defined in claim 7, wherein the angle is 138 degrees.

9. The shaft as defined in claim 4, wherein the upper and lower portions of the outer wall define a bore thereinbetween and the shaft further comprises:
a web disposed within the bore and connected to each of the upper and lower portions of the outer wall.

10. The shaft as defined in claim 9, wherein the web extends from proximate the first end of the outer wall to proximate the second end thereof.

11. The shaft as defined in claim 10, wherein the web comprises an X-shaped member that extends between an interior surface of each of the upper and lower portions of the outer wall.

12. The shaft as defined in claim 11, wherein the X-shaped member comprises a right upper leg, a left upper leg, a right lower leg and a left lower leg, and wherein each of the right upper leg, left upper leg, right lower leg and left lower leg intersect each other at a core.

13. The shaft as defined in claim 12, wherein the right upper leg and right lower leg are disposed at an angle relative to each other; and the left upper leg and left lower leg are disposed at the same angle relative to each other, and the angle is in the range of 30 degrees to 80 degrees.

14. The shaft as defined in claim 13, wherein the angle is in the range of 60 degrees to 70 degrees.

15. The shaft as defined in claim 14, wherein the angle is 67.6 degrees.

16. The shaft as defined in claim 12, wherein the core is geometrically and physically located intermediate the upper and lower portions.

17. The shaft as defined in claim 12, wherein the upper portion comprises an upper wall and a pair of upper angled sidewalls extending outwardly away from the upper wall and at an angle thereto; and the lower portion comprises a lower wall and a pair of lower angled sidewalls extending outwardly away from the lower wall and at the same angle thereto; and wherein each of the right upper leg and left upper leg of the web connects to one of the upper angled sidewalls, and each of the right lower leg and left lower leg of the web connects to one of the lower angled sidewalls.

18. The shaft as defined in claim 17, wherein a portion of each upper angled sidewall extends downwardly beyond the connection with the respective one of the left and right upper legs of the web, thereby forming a downwardly extending upper lip.

19. The shaft as defined in claim 18, wherein a portion of each of the lower angled sidewalls extends upwardly beyond the connection with the respective one of the left and right lower legs, thereby forming an upwardly extending lower lip that extends toward the upper lip.

20. The shaft as defined in claim 19, wherein each pair of opposed upper and lower lips are separated from each other by a spaced distance that comprises one of the openings in the outer wall.

21. The shaft as defined in claim 20, wherein the spaced distance between the upper and lower lips is between 3 mm and 9 mm in width.

22. The shaft as defined in claim 12, wherein the outer wall includes an upper closed cavity and a lower closed cavity, wherein the upper closed cavity is defined in cross-section by the upper wall, the two upper angled sidewalls, the right upper leg and the left upper leg; and wherein the lower closed cavity is defined in cross-section by the lower wall, the two lower angled sidewalls, the right lower leg and the left lower leg.

23. The shaft as defined in claim 22, wherein the outer wall includes a left and a right open cavity that are disposed between the upper and lower closed cavities and opposite each other.

24. The shaft as defined in claim 23, wherein the left open cavity is defined in cross-section by the left upper leg and the left lower leg, and the right open cavity is defined by the right upper leg and the right lower leg.

25. A shaft for a lacrosse stick comprising:
an elongate outer wall having a first end and a second end with a longitudinal axis extending therebetween;
a longitudinally-aligned central bore defined by said outer wall;
a web disposed within the bore and extending between said first and second ends; said web including:
a central core aligned along the longitudinal axis; and
four legs radiating outwardly from said core and connecting to said outer wall,
at least one longitudinal opening defined in said outer wall and extending between said first and second ends; and wherein a first portion of the outer wall and a pair of the legs of the web define a first closed cavity disposed within the bore; and a second portion of the outer wall and a different pair of the legs of the web and the opening define a first open cavity disposed within the bore, wherein said first open cavity is adapted to receive at least a portion of a hand or glove of an athlete therein when the shaft is grasped.

26. The lacrosse shaft as defined in claim 25, wherein the outer wall is generally octagonal in cross-sectional shape.

27. The lacrosse shaft as defined in claim 25, wherein a third portion of the outer wall and a third pair of the legs define a second closed cavity disposed within the bore, and said second closed cavity is opposed to the first closed cavity.

28. The lacrosse shaft as defined in claim 27, further comprising a second longitudinal opening defined in the outer wall and extending between the first and second ends thereof; and wherein a fourth portion of the outer wall, a fourth pair of legs of the web and the second opening define a second open cavity within the bore of the shaft; and the second open cavity is opposed to the first open cavity.

29. A shaft for a piece of sporting equipment comprising:
an elongate outer wall that is generally octagonal in cross-sectional shape and defines a longitudinal bore therein;
a longitudinal slot formed in the outer wall;
an X-shaped web disposed within the bore and extending along the entire length of the outer wall; said web including four legs that radiate outwardly from a central core and connect to an interior surface of the outer wall.

30. The shaft as defined in claim 29, wherein the outerwall is comprised of eight wall members disposed at angles relative to each other to form the octagonal cross-sectional shape, and wherein the slot is defined in a first one of the wall members.

31. The shaft as defined in claim 30, the shaft of 40 further comprising a second slot formed in a second wall member opposed to the first wall member, whereby the slots are opposed to each other.

32. The shaft as defined in claim 31, wherein the web divides the bore into two opposed closed cavities and two opposed open cavities, wherein the open cavities each include one of the slots in the outer wall.
